(19) United States
(12) Patent Application Publication
(10) Pub. No.: US 2018/0205616 A1
(43) Pub. Date: Jul. 19, 2018

(54) INTELLIGENT ORCHESTRATION AND FLEXIBLE SCALE USING CONTAINERS FOR APPLICATION DEPLOYMENT AND ELASTIC SERVICE

(71) Applicant: International Business Machines Corporation, Armonk, NY (US)

(72) Inventors: Xiao Bing Liu, Beijing (CN); Yi Bin Wang, Beijing (CN); Xin Yang, Beijing (CN); Chao Yu, Ningbo (CN); Jin Rong Zhao, Ningbo (CN)

(21) Appl. No.: 15/408,550

(22) Filed: Jan. 18, 2017

(51) Int. Cl. H04L 12/24; H04L 29/08; H04L 12/911

(52) U.S. Cl. CPC H04L 41/145; H04L 47/822; H04L 67/10; H04L 41/5045

(57) ABSTRACT

Orchestrating flexible scaling for large scale deployment and elastic service of an application of a service model with an orchestration. The orchestration: analyzes input received from a user to generate feature references and a service definition of the application of the service model to be generated, extracts key features of the application of the service model from the feature references; analyzing the key features and service definition to generate a deployment configuration file with service dependencies required; and comparing the deployment configuration file to known strategy patterns. When a strategy pattern is not found that matches, analyzing the service definition and deployment configuration file to determine an applicable strategy pattern. The determined strategy pattern analyzed to determine a deployment strategy and entry point with deployment order according to monitored resource usage of the service model and deploying the application of the service model according to the deployment strategy.

### BACKGROUND

The present invention relates to application deployment and elastic service, and more specifically to intelligent orchestration and flexible scale using containers for application deployment and elastic service.

Docker container technology is very popular in the cloud computing platform. But, the container cannot be regarded as a complete Platform as a Service (PaaS) technology, since it relies on relatively obscure and difficult understanding of a YAML Ain't Markup Language (YAML) profile when deploying large-scale applications with many kinds of services in the docker environment.

Different applications have different usage scenarios and different resource requirements. But, current major orchestration engines cannot make an intelligent orchestration strategy based on the current resource utilization and application usage scenarios and therefore, applications can have a variety of performance issues during running, such as short-term visit spikes, causing related resources to be difficult to use elastically. Furthermore, the engines do not consider customized container placement requirements, especially in special testing scenarios, such as placing containers in a single operating system, placing containers in signal host mode, or placing containers in group host nodes.

### SUMMARY

According to one embodiment of the present invention, a method of orchestrating flexible scaling for large scale deployment and elastic service of an application of a service model with an orchestration comprising at least a semantics analysis engine, a container deployment engine, and a strategy repository is disclosed. The method comprising the steps of: analyzing input received from a user to generate feature references and a service definition of the application of the service model to be generated; extracting key features of the application of the service model from the feature references; analyzing the key features and service definition to generate a deployment configuration file with service dependencies required by the application of the service model specified by the user; comparing the deployment configuration file to known strategy patterns; when a strategy pattern is not found that matches the service definition and the deployment configuration file, analyzing the service definition and deployment configuration file to determine an applicable strategy pattern; analyzing the determined strategy pattern to determine a deployment strategy, container pod, and entry point with deployment order according to monitored resource usage of the service model; and deploying the application of the service model according to the deployment strategy.

According to another embodiment of the present invention, a computer program product for orchestrating flexible scaling for large scale deployment and the elastic service of the container deployment engine is disclosed. The orchestration comprising at least one processor, one or more memories, one or more computer readable storage media, the computer program product comprising a computer readable storage medium having program instructions embodied therewith. The program instructions executable by the computer to perform a method comprising: analyzing, by the orchestration, input received from a user to generate feature references and a service definition of the application of the service model to be generated; extracting, by the orchestration, key features of the application of the service model from the feature references; analyzing, by the orchestration, the key features and service definition to generate a deployment configuration file with service dependencies required by the application of the service model specified by the user; comparing, by the orchestration, the deployment configuration file to known strategy patterns; when a strategy pattern is not found that matches the service definition and the deployment configuration file, analyzing, by the orchestration, the service definition and deployment configuration file to determine an applicable strategy pattern; analyzing, by the orchestration, the determined strategy pattern to determine a deployment strategy, container pod, and entry point with deployment order according to monitored resource usage of the service model; and deploying, by the orchestration, the application of the service model according to the deployment strategy.

According to another embodiment of the present invention, a computer system for orchestrating flexible scaling for large scale deployment and the elastic service of the container deployment engine is disclosed. The orchestration comprising a computer comprising at least one processor, one or more memories, one or more computer readable storage media having program instructions executable by the computer to perform the program instructions. The program instructions comprising: analyzing, by the orchestration, input received from a user to generate feature references and a service definition of the application of the service model to be generated; extracting, by the orchestration, key features of the application of the service model from the feature references; analyzing, by the orchestration, the key features and service definition to generate a deployment configuration file with service dependencies required by the application of the service model specified by the user; comparing, by the orchestration, the deployment configuration file to known strategy patterns; when a strategy pattern is not found that matches the service definition and the deployment configuration file, analyzing, by the orchestration, the service definition and deployment configuration file to determine an applicable strategy pattern; analyzing, by the orchestration, the determined strategy pattern to determine a deployment strategy, container pod, and entry point with deployment order according to monitored resource usage of the service model; and deploying, by the orchestration, the application of the service model according to the deployment strategy.

### BRIEF DESCRIPTION OF THE SEVERAL VIEWS OF THE DRAWINGS

FIG. 1 depicts a cloud computing node according to an embodiment of the present invention.

FIG. 2 depicts abstraction model layers according to an embodiment of the present invention.

FIG. 3 shows a schematic of orchestration of flexible scaling for large scale deployment and elastic service.

FIG. 4 shows a method of orchestrating flexible scaling for large scale deployment and elastic service.

### DETAILED DESCRIPTION

Current docker orchestration engines mainly focus on how to deploy an application with an unreadable YAML configuration file. However, current orchestration engines do not consider host physical resource utilization (i.e., CPU, Memory, Disk or Network) for the scheduler. Furthermore, application running processes are not analyzed so as to allow dynamic adjustment of the container services scale.

It will be recognized that in embodiments of the present invention, container technology is used to provide intelligent orchestration, dynamic deployment for application delivery, and special testing scenarios. Application configuration can be simplified as a nature language input, which can be converted to complex configuration files with a semantic analysis engine and pattern repository generating optimal placement strategy based on monitoring of current resource utilization.

It will be recognized that in embodiments of the present invention, intelligent orchestration and flexible scaling for large-scale deployment and elastic service through analyzation of user's input intelligently, permits extraction of readable configuration for deployment. Based on the user's input, a deployment strategy is dynamically determined and includes the deployment entry point with deployment order. Entry points identify the resources that are access points to an application, and control users' access to different versions of an application that is deployed.

The embodiments of the present invention also consider customized container placement requirement, such that different usage scenarios and different business purpose, especially in DevOps pipeline and special testing scenarios, can be intelligently orchestrated.

The embodiments of the present invention can be used with Platform as a Service (PaaS) cloud computing service models. The embodiments of the present invention can improve resource utilization with intelligent orchestration and deployment adaptable to different business scenarios and cloud performance challenges.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

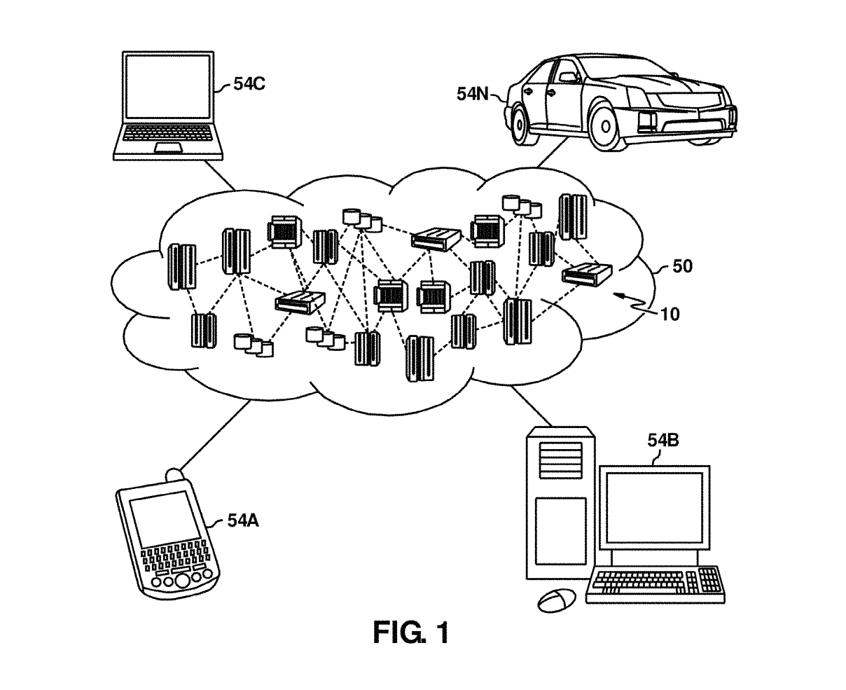

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer MB, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

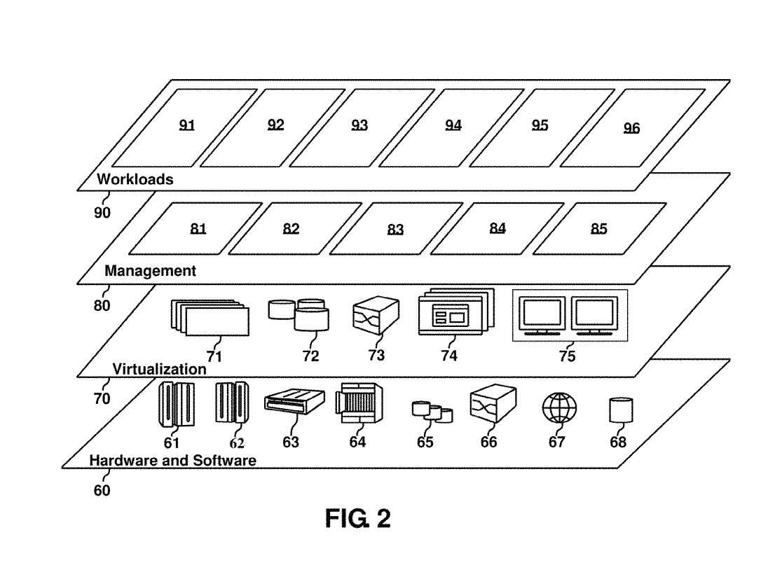

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and intelligent flexible scale orchestration 96.

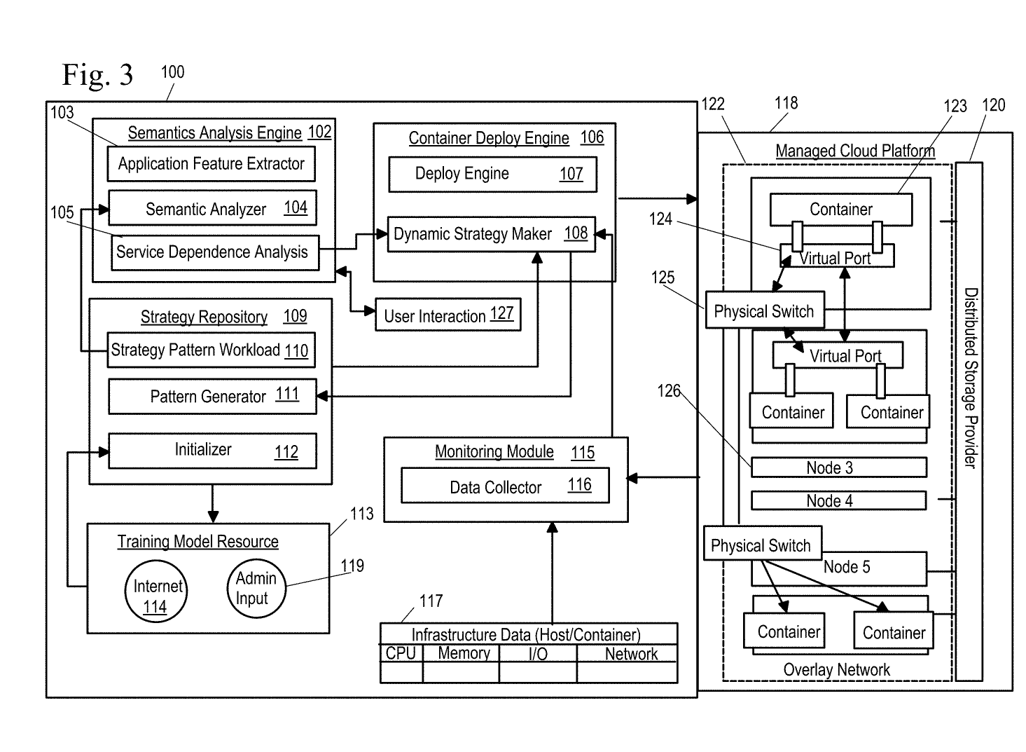

FIG. 3 shows a schematic of orchestration 100 of flexible scaling for large scale deployment and elastic service.

The orchestration 100 of flexible scaling for large scale deployment and elastic service includes semantic analysis, dynamic strategy and elastic service. The orchestration 100 includes a semantics analysis engine 102, a strategy repository 109, a training model resource 113, a monitoring module 115 and a container deploy engine 106, which receives and provides feedback to a managed cloud platform 118.

The managed cloud platform 118 is connected to a distributed storage provider 120 for containers file distribution in different nodes. The managed cloud platform 118 also has overlay networks 122 based on physical switches 125 and/or virtual ports 124 which is used for containers 123 communication in different nodes 123. Additional nodes may also be present.

A semantics analysis engine 102 receives a natural language input from user interaction 127 which can include a natural language definition (not shown), and input from a strategy repository 109. The semantics analysis engine 102 is used to analyze the user's brief purpose input using semantic analysis and generate a readable configuration file for deployment. The output of the semantics analysis engine 102 is sent to a container deploy engine 106. Output may also be provided to the user by the semantics analysis engine 102.

The semantics analysis engine 102 includes three components, an application feature extractor 103, a semantic analyzer 104 and a service dependence analysis component 105.

The application feature extractor 103 analyzes a user's input to extract an application's key features according to the semantic analyzer 104 and generates a readable configuration file for deployment through service dependence analysis discussed in further detail below. The application feature may include, but is not limited to, CPU intensive and memory intensive, which is used in determining the next deployment logic.

The semantic analyzer 104 analyzes the input and searches the strategy repository 109 to generate at least one feature for the application feature extractor 103. The feature reference or references extracted may be regarding the environment (i.e. testing environment, development environment). The semantic analyzer 104 also generates a service dependency configuration.

In the case of customized models, users can replace default optimal features extracted by the application feature extractor 103. User interaction 127 allows the user to refine the generated features and associated strategy and create a customized placement policy. For example, the user provides input for deploying a single CPU intensive node or deploying a single Input/Output intensive node. The service dependence analysis component 105 then analyzes the result of the application feature extractor 103 which, in this example, is overridden by user interaction, and generates a deployment configuration file. In other words, service dependency analysis component 105 analyzes keywords and generates all of the service dependencies needed by the target application of the user.

The semantic analyzer 104 caches all the deployment processes and acts as a repository for semantics analysis engine 102. The semantic analyzer 104 acts as character/feature extracting repository for the application features extractor 103. For example, if the user input is DevOps Java, the application feature extractor (AFE) 103 will search through the strategy repository 109 and determine whether to create an application with a continuous integration (CI) service, code repository service, testing service and build service with the Java platform.

The service dependence analysis component 105 decomposes a service node into some light containers which can be recognized by a docker engine as shown in FIG. 3 with Node 5. More specifically, service dependence analysis (SDA) component 105 analyzes the results of the application feature extractor 103 and generates a deployment configuration file. The service dependence analysis component 105 also generates a table for next components, which is the dependency schema. For example, the application feature extractor 103 provides CI service code, repository service, testing service and build service with a Java platform. The service dependence analysis component 105 will also monitor the semantic analyzer 104 and provide a directive deployment configuration file and mark the deployment as a stable feature.

For example, the configuration file could include the following:

Scenario: DevOps
Deploy-feature:stable
Services:

repository:

-git-service:gitlab
-git-db:mysql
-git-redis:redis

deploy:docker_engine
registry:docker-registry
test+ci+build:selenium+Jenkins+maven

A strategy repository 109 is connected to the semantics analysis engine 102 and provides input. Input is also provided to the strategy repository 109 from a training model resource 113 and the container deploy engine 106. The strategy repository 109 contains a strategy pattern workload 110, a pattern generator 111, and an initializer 112.

The strategy repository 109 is initialized through the initializer 112 by a training model resource 113, which can be collected from the Internet 114 or inputted by administrator 119. The initializer 112 can generate patterns from the input provided by the training model resource 113.

The strategy pattern workload 110 of the strategy repository 109 includes pattern routes which can guide the semantic analyzer 104 to analyze the natural language input and help strategy maker 108 find a matching pattern. The pattern generator 111 of the strategy repository 109 is the deployment pattern source and caches all of the dynamic strategy maker 108 processes and aids in converting these strategies to pattern to enrich the strategy repository 109, thus using the historical data to create new deployment patterns. A pattern is a guidance for further deployment according to the configuration file, which describes the deployment strategy and error handling. For example, a pattern could include the following:

Scenario: DevOps
Deploy-feature:stable
Services:

repository:

-git-service:gitlab
-git-db:mysql
-git-redis:redis

strategy: pod,singlehost
error-handling: rebuild

deploy:docker_engine

strategy: random
error-handling: restart

registry:docker-registry

strategy: ssd-host
error-handling: restart

test+ci+build:selenium+Jenkins+maven

strategy: spread
error-handling: rebuild

A container deploy engine 106 is used to determine the deployment strategy and entry point with deployment order according to monitored resource usage to the managed cloud platform 118. For example, a deployment strategy with deployment order and an entry point could include:

Scenario: DevOps
Deploy-feature:stable
Services:

repository:

-git-service:gitlab
-git-db:mysql
-git-redis:redis

strategy: pod,singlehost
error-handling: rebuild
entry-point: yes
order: 1

deploy:docker_engine

strategy: random
error-handling: restart
entry-point: no
order: 3

registry:docker-registry

strategy: ssd-host
error-handling: restart

entry-point: no

order: 2

test+ci+build:selenium+Jenkins+maven

strategy: spread
error-handling: rebuild

entry-point: no

order: 2

The container deploy engine 106 receives input from the semantics analysis engine 102, a monitoring module 115 and a strategy repository 109. The container deploy engine 106 sends an output to the managed cloud platform 118 and pattern generator 111 of the strategy repository 109.

The service container deploy engine 106 contains a deploy engine 107 and a dynamic strategy maker 108. The service container deploy engine 106 receives the configuration file, which is the service definition.

The dynamic strategy maker (DSM) 108 analyzes the result of the service dependence analysis 105 and searches the strategy pattern workload 110 of the strategy repository 109. If a strategy pattern matches business requirements, the dynamic strategy maker 108 can generate a deployment strategy based on the dependency schema provided by the service dependency analysis component 105 and infrastructure data from the monitoring module 115 to determine the deployment entry point and container pods. With a container pod being a group of containers for a single service, which should be deployed in a single host, uses the same namespace and expose a single port. Containers in a pod can communicate with each from localhost.

For example, based on an input of a deployment requirement of placement description of the requester and related inputs of User Interaction 127, semantic Analyzer 104 would analyze related inputs to provide inputs for deploy engine and the deployment strategy could be three repository containers should be deployed in a single host and expose 80 port.

If a strategy pattern does not match the business requirements, the dynamic strategy maker 108 analyzes the application features to determine the container pod and entry point intelligently.

For example, a user may want to do a performance test for his ERP application with a database and application server in a single host with more than 12 core CPUs, 48 GB Memory and 1 TB storage. His input could include the following:

appName: ERP
souceCodeLink: http://xxxx/xxx.git
databaseScript: ftp://xxxx/xxx.sql
scenario: {

type: Performance-Test,
limitation: {

cpu: 12 core,
memory: 48GB
storage: 1TB

}

}

Thus, the dynamic strategy maker 108 analyzes will analyze user input to generate the following configuration file with dependency schema and features extracted:

Scenario: Performance-Test
Deploy-feature: quick, integration, test
Service:

- build-service: maven

code-repository: http://xxxx/xxx.git

- web-service: apache tomcat
- database: mysql

ink-script: ftp://xxxx/xxx.sql

```
Limitation:
  cpu: 12 core
  memory: 48GB
  storage: 1TB
```

User interaction allows the user to refine the generated strategy. The deployment strategy only determines a first deployment entry and container pod. The next deployment entry point will be generated dynamically based on deployment result and real time resource rating. The dynamic strategy maker 108 rates the infrastructure resource with equation 1.1, whose performance parameters are collected by the monitoring module 115 in real time. The dynamic strategy maker 108 determines which resource will be used for deployment based on application features and rating results and fulfills all of the deployment. It should be noted that during the deployment process, deployment results are always provided as input to the dynamic strategy maker 108, such that a retry action can be executed if failure of the deployment occurs and for determining the next deployment entry point.

$$rating = {\sum }_{i = 1}^{n} ( 1 - {usage}_{i} / {total}_{i} ) * {weighter}_{i} \qquad ( 1.1 )$$

The deploy engine 107 dynamically deploys the deployment process according to an order and adjusts the deployment order according to the monitoring resource utilization to rate the candidate hosts during the deployment process. The deploy engine 107 deploys containers and provides feedback to the dynamic strategy maker 108 to retry if failure happens and determine the next deployment entry point. The deployment process can also be cached by the semantic analyzer 104.

The monitoring module 115 receives input from the managed cloud platform 118 of infrastructure data 117 in real time. The infrastructure data can include, but is not limited to: memory usage, input/output (I/O), network, and host computer processing unit (CPU) usage. The infrastructure data is used by the dynamic strategy maker 108 to generate a deployment strategy. The infrastructure data can additionally contain infrastructure of the host relative to the container. Additionally performance data can also be provided as input and can include response timeout, physical volume (PV), and the ratio between queries per second and transactions per second. The monitoring module 115 contains a data collector 116.

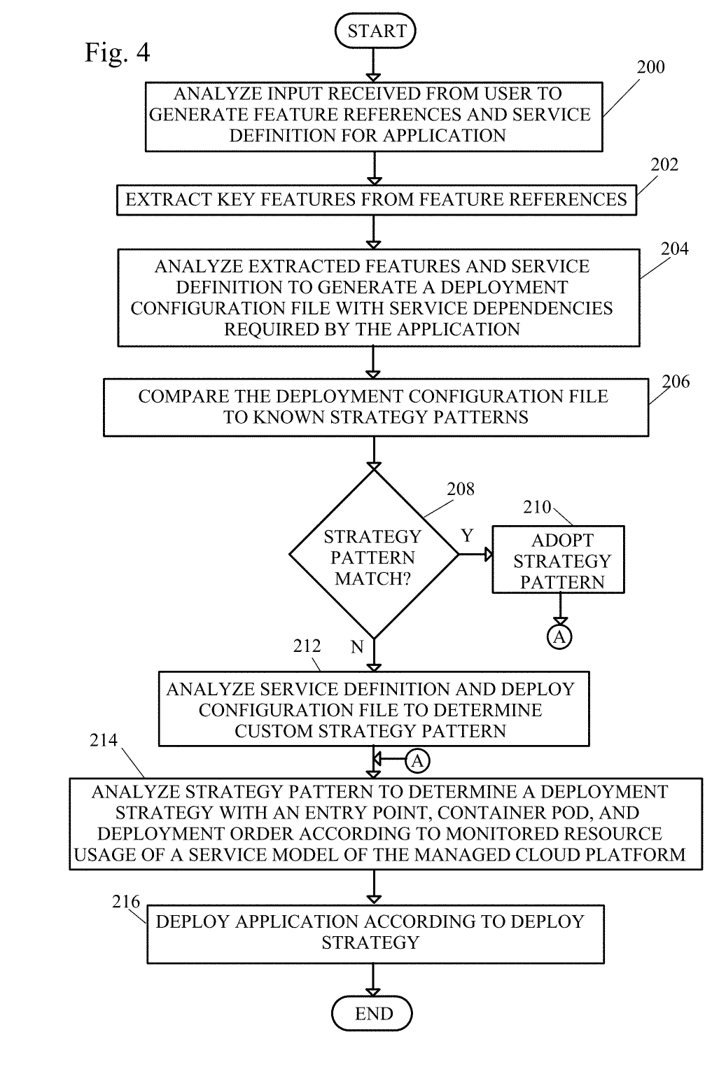

FIG. 4 shows a method of orchestrating flexible scaling for large scale deployment and elastic service of a service model of the cloud managed platform.

Input received from the user is analyzed to generate feature references and a service definition of an application of a service model of the cloud managed platform to be generated (step 200). For example, the semantic analyzer analyses the input, which is preferably a natural language input, to provide a reference for the application feature extractor 103. The service definition preferably includes the service dependencies needed.

Key features of the application are extracted from the feature references (step 202), for example by the application feature extractor 103 and semantic analyzer 104 of the semantic analysis engine 102 of the orchestration 100.

The extracted features and service definition are analyzed to generate a deployment configuration file with service dependencies required by the application of the service model (step 204), for example by the service dependency analysis component 105 of the orchestration 100. The service dependencies can also be set by the user.

The deployment configuration file is compared to previously used or known strategy patterns (step 206), for example by the dynamic strategy maker 108.

If a strategy pattern is found that matches the service definition and the deployment configuration file (step 208), the strategy pattern is adopted (step 210) and the method continues to step 214. The determined strategy pattern can be presented to the user for additional feedback. The determined strategy pattern can be altered based on the additional user feedback. The strategy pattern includes at least container type and entry point.

If a strategy pattern is not found that matches the service definition and the deployment configuration file (step 208), the service definition and deployment configuration file are analyzed to determine a custom applicable strategy pattern (step 212) and the method continues to step 214. The custom strategy pattern can be stored in the strategy repository 109. The custom applicable strategy pattern is determined by the dynamic strategy maker 108, which assigns a strategy pattern of ‘random’ by default and allows user to refine the generated strategy via user interaction 127. The user can change the strategy pattern from ‘random’ to ‘spread’ or ‘pod’, and then dynamic strategy maker 108 can refresh the deployment strategy accordingly.

The determined strategy pattern is analyzed to determine a deployment strategy with an entry point, container pod, and deployment order according to monitored resource usage of a service model of the managed cloud platform (step 214), for example by the container deploy engine 106. The deployment strategy includes which resources are used for deployment based on the application features extracted and fulfillment of all of the deployment.

The application of the service model which includes containers and other associated resources are then deployed according to the deployment strategy (step 216), for example through the deployment engine 107 and the method ends.

After the containers and other associated resources are deployed, feedback can be provided to a monitoring module 115 which provides input to the dynamic strategy maker 108 of the container deploy engine 106 to adjust the deployment as necessary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of orchestrating flexible scaling for large scale deployment and elastic service of an application of a service model with an orchestration comprising at least a semantics analysis engine, a container deployment engine, and a strategy repository, comprising the steps of:
analyzing input received from a user to generate feature references and a service definition of the application of the service model to be generated;
extracting key features of the application of the service model from the feature references;
analyzing the key features and service definition to generate a deployment configuration file with service dependencies required by the application of the service model specified by the user;
comparing the deployment configuration file to known strategy patterns;
when a strategy pattern is not found that matches the service definition and the deployment configuration file, analyzing the service definition and deployment configuration file to determine an applicable strategy pattern;
analyzing the determined strategy pattern to determine a deployment strategy, container pod, and entry point with deployment order according to monitored resource usage of the service model; and
deploying the application of the service model according to the deployment strategy.

2. The method of claim 1, wherein the deployment strategy further comprises which resources are used for deployment based on the key features extracted from the feature references.

3. The method of claim 1, wherein the orchestration further comprises a monitoring module providing feedback regarding resources of the model service.

4. The method of claim 1, wherein the strategy pattern comprises container type and entry point for the service model.

5. The method of claim 1, wherein the service model is provided as a service in a cloud environment.

6. A computer program product for orchestrating flexible scaling for large scale deployment and the elastic service of the container deployment engine comprising at least one processor, one or more memories, one or more computer readable storage media, the computer program product comprising a computer readable storage medium having program instructions embodied therewith, the program instructions executable by the computer to perform a method comprising:
analyzing, by the orchestration, input received from a user to generate feature references and a service definition of the application of the service model to be generated;
extracting, by the orchestration, key features of the application of the service model from the feature references;
analyzing, by the orchestration, the key features and service definition to generate a deployment configuration file with service dependencies required by the application of the service model specified by the user;
comparing, by the orchestration, the deployment configuration file to known strategy patterns;
when a strategy pattern is not found that matches the service definition and the deployment configuration file, analyzing, by the orchestration, the service definition and deployment configuration file to determine an applicable strategy pattern;
analyzing, by the orchestration, the determined strategy pattern to determine a deployment strategy, container pod, and entry point with deployment order according to monitored resource usage of the service model; and
deploying, by the orchestration, the application of the service model according to the deployment strategy.

7. The computer program product of claim 6, wherein the deployment strategy further comprises which resources are used for deployment based on the key features extracted from the feature references.

8. The computer program product of claim 6, wherein the orchestration further comprises a monitoring module providing feedback regarding resources of the model service.

9. The computer program product of claim 6, wherein the strategy pattern comprises container type and entry point for the service model.

10. The computer program product of claim 6, wherein the service model is provided as a service in a cloud environment.

11. A computer system for orchestrating flexible scaling for large scale deployment and the elastic service of the container deployment engine comprising a computer comprising at least one processor, one or more memories, one or more computer readable storage media having program instructions executable by the computer to perform the program instructions comprising:
analyzing, by the orchestration, input received from a user to generate feature references and a service definition of the application of the service model to be generated;
extracting, by the orchestration, key features of the application of the service model from the feature references;
analyzing, by the orchestration, the key features and service definition to generate a deployment configuration file with service dependencies required by the application of the service model specified by the user;
comparing, by the orchestration, the deployment configuration file to known strategy patterns;
when a strategy pattern is not found that matches the service definition and the deployment configuration file, analyzing, by the orchestration, the service definition and deployment configuration file to determine an applicable strategy pattern;
analyzing, by the orchestration, the determined strategy pattern to determine a deployment strategy, container pod, and entry point with deployment order according to monitored resource usage of the service model; and
deploying, by the orchestration, the application of the service model according to the deployment strategy.

12. The computer system of claim 11, wherein the deployment strategy further comprises which resources are used for deployment based on the key features extracted from the feature references.

13. The computer system of claim 11, wherein the orchestration further comprises a monitoring module providing feedback regarding resources of the model service.

14. The computer system of claim 11, wherein the strategy pattern comprises container type and entry point for the service model.

15. The computer system of claim 11, wherein the service model is provided as a service in a cloud environment.
